(19) United States
(12) Patent Application Publication
(10) Pub. No.: US 2025/0232208 A1
(43) Pub. Date: Jul. 17, 2025

(54) CONSTRAINT-BASED OPTIMIZATION OF MACHINE LEARNING MODELS

(71) Applicant: FMR LLC, Boston, MA (US)

(72) Inventors: Saloni Priyani, Pittsburgh, PA (US); Nikhil Krishnegowda, Hassan (IN); Samir Kakkar, Bangalore (IN)

(21) Appl. No.: 18/411,660

(22) Filed: Jan. 12, 2024

(51) Int. Cl. G06N 20/00

(52) U.S. Cl. CPC G06N 20/00

(57) ABSTRACT

Methods and apparatuses for constraint-based optimization of machine learning classification models include determining performance constraints associated with deployment and execution of a model and identifying candidate pipelines. For each candidate pipeline, a model is trained using a training dataset, the trained model is executed using a testing dataset to determine performance characteristics for the trained model, and the performance characteristics are compared to the performance constraints. One of the candidate model pipelines that meets the performance constraints is identified and a production model is built based upon the identified candidate pipeline. The production model is deployed to a production computing environment for execution.

### TECHNICAL FIELD

This application relates generally to methods and apparatuses, including computer program products, for constraint-based optimization of machine learning (ML) models.

### BACKGROUND

Recently, advanced data analysis methodologies that rely on machine learning, such as classification models, have become widely available. As can be appreciated, deployment and execution of classification models typically requires significant computing resources (e.g., CPU, memory) and lengthy periods of iteration and refinement in order to accurately perform the functions for which they are designed. With unlimited computing resources and unlimited time, ML models can be designed to achieve very accurate performance. In many production environments, however, computing resources and development time is limited due to overhead, availability, and cost. System administrators and model designers are required to impose performance constraints on classification models in order to satisfy any imposed limitations. This can impact the performance and accuracy of the resulting models—which makes choice of classification algorithms, hyperparameter tuning, and data processing techniques used to build the model even more important. In spite of these limitations, production classification models must still be able to generate results that are as accurate as possible in real-time or near real-time while also working under the designated performance constraints and restrictions.

In addition, most classification models are static-meaning once they are deployed to a production environment, the algorithms they use and the analysis they perform does not change. In contrast, the data being provided to such classification models for analysis does change over time which can result in a decrease in accuracy from the classification model.

### SUMMARY

Therefore, what is needed are methods and systems that can automatically optimize and deploy machine learning classification models that conform to performance constraints—as well as dynamically adapt the classification models over time as algorithms and data change—with minimal intervention or reconstruction of such models. The techniques described herein advantageously capture desired performance constraints (e.g., CPU, memory, response time, accuracy) and iterate through multiple combinations of data preprocessing, classification algorithm selection, and hyperparameter tuning to automatically identify model frameworks and structures that fit into the performance constraints while also delivering optimal accuracy and performance.

The invention, in one aspect, features a system for constraint-based optimization of machine learning classification models. The system comprises a server computing device having a memory that stores computer-executable instructions and a processor that executes the computer-executable instructions. The server computing device determines performance constraints associated with deployment and execution of a machine learning classification model. The server computing device identifies a plurality of candidate classification model pipelines, each pipeline comprising a different combination of: data preprocessing techniques, a classification model algorithm, and hyperparameter tuning values. For each candidate classification model pipeline, the server computing device processes the training dataset using the data preprocessing technique, trains the classification model algorithm on the training dataset, and tunes the trained classification model algorithm using the hyperparameter tuning algorithm. For each candidate classification model pipeline, the server computing device executes the trained classification model using a testing dataset as input to determine performance characteristics for the trained model, and compares the performance characteristics to the performance constraints to identify whether the trained model meets the performance constraints. The server computing device identifies one of the candidate classification model pipelines that meets the performance constraints. The server computing device builds a production classification model based upon the identified candidate model pipeline, and deploys the production classification model in a production computing environment.

The invention, in another aspect, features a computerized method of constraint-based optimization of machine learning classification models. A server computing device determines performance constraints associated with deployment and execution of a machine learning classification model. The server computing device identifies a plurality of candidate classification model pipelines, each pipeline comprising a different combination of: data preprocessing techniques, a classification model algorithm, and hyperparameter tuning values. For each candidate classification model pipeline, the server computing device processes the training dataset using the data preprocessing techniques, trains the classification model algorithm on the training dataset, and tunes the trained classification model algorithm using the hyperparameter tuning values. For each candidate classification model pipeline, the server computing device executes the trained classification model using a testing dataset as input to determine performance characteristics for the trained model, and compares the performance characteristics to the performance constraints to identify whether the trained model meets the performance constraints. The server computing device identifies one of the candidate classification model pipelines that meets the performance constraints. The server computing device builds a production classification model based upon the identified candidate model pipeline, and deploys the production classification model in a production computing environment.

Any of the above aspects can include one or more of the following features. In some embodiments, the performance constraints comprise a maximum response time, a maximum CPU usage, a maximum memory usage, and a maximum platform execution cost. In some embodiments, the data preprocessing techniques comprise an imputation step, a feature scaling step, and an encoding step. In some embodiments, the imputation step comprises mean imputation or median imputation. In some embodiments, the feature scaling step comprises standardization or normalization. In some embodiments, the encoding step comprises one-hot encoding or dummy encoding.

In some embodiments, the classification algorithm comprises a k-nearest neighbor (KNN) algorithm or a support vector machine (SVM) algorithm. In some embodiments, when the classification model algorithm is a KNN algorithm, the hyperparameter tuning values correspond to an n-leaf parameter and a number of neighbors parameter. In some embodiments, when the classification algorithm is a SVM algorithm, the hyperparameter tuning values correspond to a c-parameter and a gamma parameter.

In some embodiments, the performance characteristics comprise response time, CPU usage, memory usage, and classification accuracy. In some embodiments, identifying one of the candidate classification model pipelines that meets the performance constraints comprises selecting a candidate ML classification model pipeline associated with an optimal classification accuracy.

In some embodiments, the server computing device periodically updates the performance constraints, the training dataset, and the testing dataset. For each candidate ML classification model pipeline, the server computing device processes the updated training dataset using the data preprocessing technique, trains the classification model algorithm on the updated training dataset, tunes the trained classification model algorithm using the hyperparameter tuning algorithm, executes the trained ML classification model using the updated testing dataset as input to determine performance characteristics for the trained model, and compares the performance characteristics to the plurality of performance constraints to identify whether the trained model meets the performance constraints. The server computing device identifies one of the candidate ML classification model pipelines that meets the updated performance constraints. The server computing device builds a new production ML classification model based upon the identified candidate ML model pipeline and deploys the new production ML classification model to the production computing environment.

Other aspects and advantages of the invention will become apparent from the following detailed description, taken in conjunction with the accompanying drawings, illustrating the principles of the invention by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of a system for constraint-based optimization of machine learning classification models.

FIG. 2 is a flow diagram of a computerized method of constraint-based optimization of machine learning classification models.

FIG. 3 is a diagram of an exemplary user interface for capturing baseline performance constraints.

FIG. 4 is a detailed workflow diagram of pipeline generation performed by the system.

FIG. 5 is a detailed block diagram of a pipeline generation module and a model training and testing module used in the system.

### DETAILED DESCRIPTION

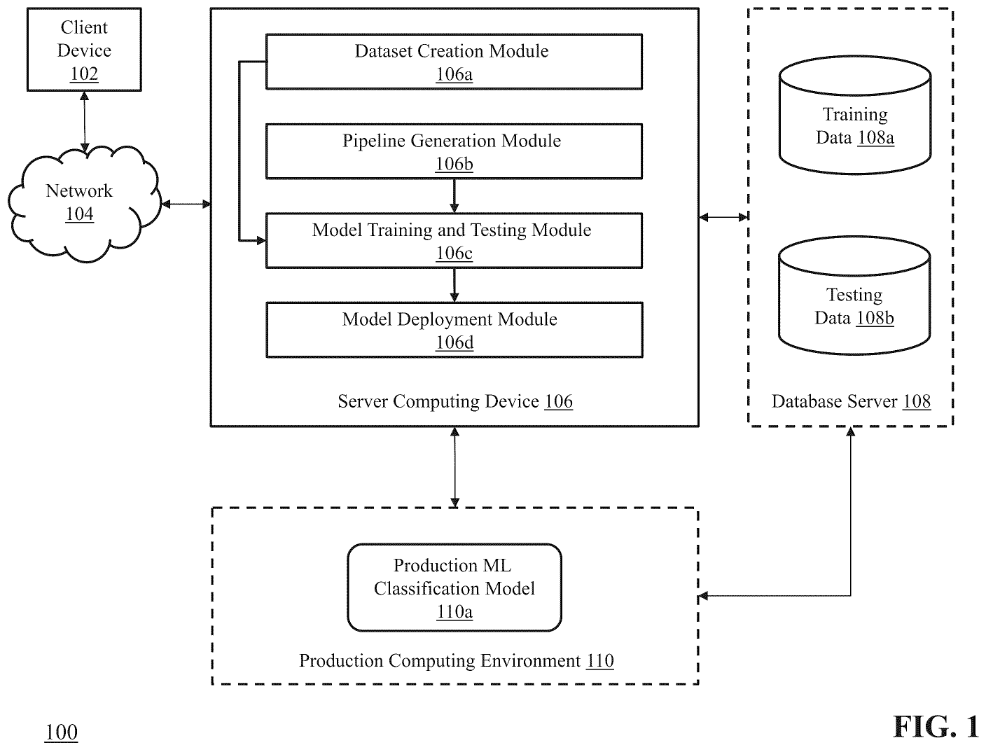

FIG. 1 is a block diagram of system 100 for constraint-based optimization of machine learning (ML) classification models. System 100 includes client computing device 102, communication network 104, server computing device 106 that includes dataset creation module 106a, pipeline generation module 106b, model training and testing module 106c, and model deployment module 106d, database server 108 comprising training data database 108a and testing data database 108b, and production computing environment including production ML classification model 110a.

Client computing device 102 connects to communication network 104 in order to communicate with server computing device 106 to provide input and receive output relating to the process of constraint-based optimization of machine learning classification models as described herein. In some embodiments, client computing device 102 is coupled to an associated display device (not shown). For example, client computing device 102 can provide a graphical user interface (GUI) via the display device that is configured to receive input from a user of the device 102 and to present output to the user that results from the methods and systems described herein.

Exemplary client computing devices 102 include but are not limited to desktop computers, laptop computers, tablets, mobile devices, smartphones, and internet appliances. It should be appreciated that other types of computing devices that are capable of connecting to the components of system 100 can be used without departing from the scope of invention. Although FIG. 1 depicts a single client computing device 102, it should be appreciated that system 100 can include any number of client computing devices.

Communication network 104 enables the client computing device 102 to communicate with server computing device 106. Network 104 is typically a wide area network, such as the Internet and/or a cellular network. In some embodiments, network 104 is comprised of several discrete networks and/or sub-networks (e.g., cellular to Internet).

Server computing device 106 is a device including specialized hardware and/or software modules that execute on one or more processors and interact with one or more memory modules of server computing device 106, to receive data from other components of system 100, transmit data to other components of system 100, and perform functions for constraint-based optimization of machine learning classification models as described herein. As mentioned above, server computing device 106 includes dataset creation module 106a, pipeline generation module 106b, model training and testing module 106c, and model deployment module 106d which each execute on one or more processors of server computing device 106. In some embodiments, modules 106a-106d are specialized sets of computer software instructions programmed onto one or more dedicated processors in the server computing device 106 and can include designated memory locations and/or registers for executing the specialized computer software instructions.

Although modules 106a-106d are shown in FIG. 1 as executing within the same server computing device 106, in some embodiments the functionality of modules 106a-106d can be distributed among a plurality of server computing devices. As shown in FIG. 1, server computing device 106 enables modules 106a-106d to communicate with each other in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. The exemplary functionality of modules 106a-106d is described in detail throughout the specification.

Database server 108 is a computing device (or set of computing devices) coupled to server computing device 106. Server 108 is configured to receive, generate, and store specific segments of data relating to the process of constraint-based optimization of machine learning classification models as described herein. Database server 108 comprises a plurality of databases 108a-108b, including training data database 108a and testing data database 108b. In some embodiments, all or a portion of the databases 108a-108b can be integrated with server computing device 106 or be located on a separate computing device or devices. Databases 108a-108b can comprise one or more databases configured to store portions of data used by the other components of system 100, as will be described in greater detail below.

Production computing environment 110 comprises one or more computing devices coupled to server computing device 106 and database server 108. Production computing environment 110 hosts one or more machine learning classification models (i.e., model 110a) that are configured according to model pipelines generated by server computing device 106. The ML classification models hosted in production computing environment can receive input data from one or more external data sources and process the data to, e.g., generate output. Generally, a machine learning classification model is configured to perform one or more tasks, such as automated classification of input data into one or more groups or categories according to features of the input data. In some embodiments, ML model 110a is trained on existing datasets with known classification values/labels to generate predictions of classification values/labels for datasets that have not been labeled. An example label can be a binary value (e.g., 0 for or 1), an alphanumeric value, or other types of labeling mechanisms. Other computing systems can connect to production computing environment 110 to provide input data to ML model 110a, which classifies the input data and returns the classified data to the requesting system. The requesting system can analyze the classifications generated by ML model 110a to, e.g., take further actions such as identifying data for priority analysis, providing content recommendations, and/or predicting future user activity-among other functions.

In some embodiments, production computing environment 110 is a cloud-based environment with resources distributed into a plurality of regions defined according to certain geographic and/or technical performance requirements. Each region can comprise one or more datacenters connected via a regional network that meets specific low-latency requirements. Inside each region, cloud computing environment 104 can be partitioned into one or more availability zones (AZs), which are physically separate locations used to achieve tolerance to, e.g., hardware failures, software failures, disruption in connectivity, unexpected events/disasters, and the like. Typically, the availability zones are connected using a high-performance network (e.g., round trip latency of less than two milliseconds). It should be appreciated that other types of computing resource distribution and configuration in a cloud environment can be used within the scope of the technology described herein. In some embodiments, production computing environment 110 is a local computing environment (also called an ‘on-prem’ environment) comprising physical and/or virtual computing resources in a defined location. It should be appreciated that in some embodiments, production computing environment 110 comprises a hybrid on-prem and cloud-based computing environment.

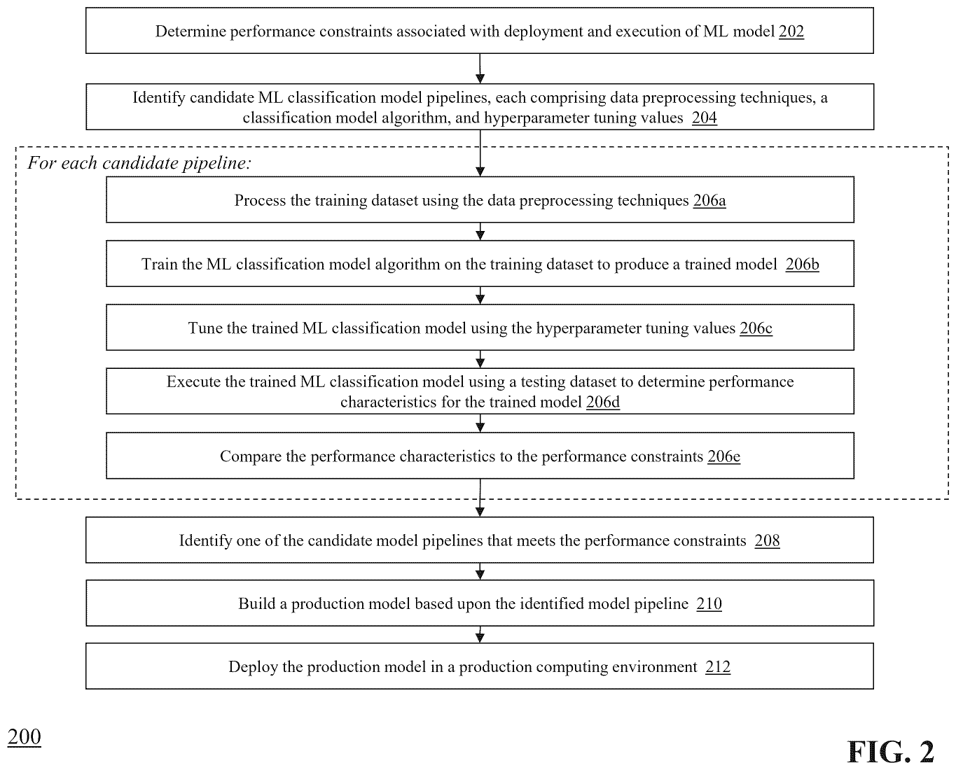

FIG. 2 is a flow diagram of a computerized method 200 of constraint-based optimization of machine learning classification models, using system 100 of FIG. 1. Pipeline generation module 106b of server computing device 106 determines (step 202) a plurality of performance constraints associated with deployment and execution of a machine learning classification model. As can be appreciated, deployment and execution of ML classification models typically require significant computing resources (e.g., CPU, memory) in order to accurately perform the functions for which they are designed. With unlimited computing resources, ML models can be designed to achieve very accurate performance. In many production environments, however, computing resources are restricted due to overhead, availability, and cost. Therefore, production ML models must be able to generate results that are as accurate as possible in real-time or near real-time while also working under the designated performance constraints and restrictions.

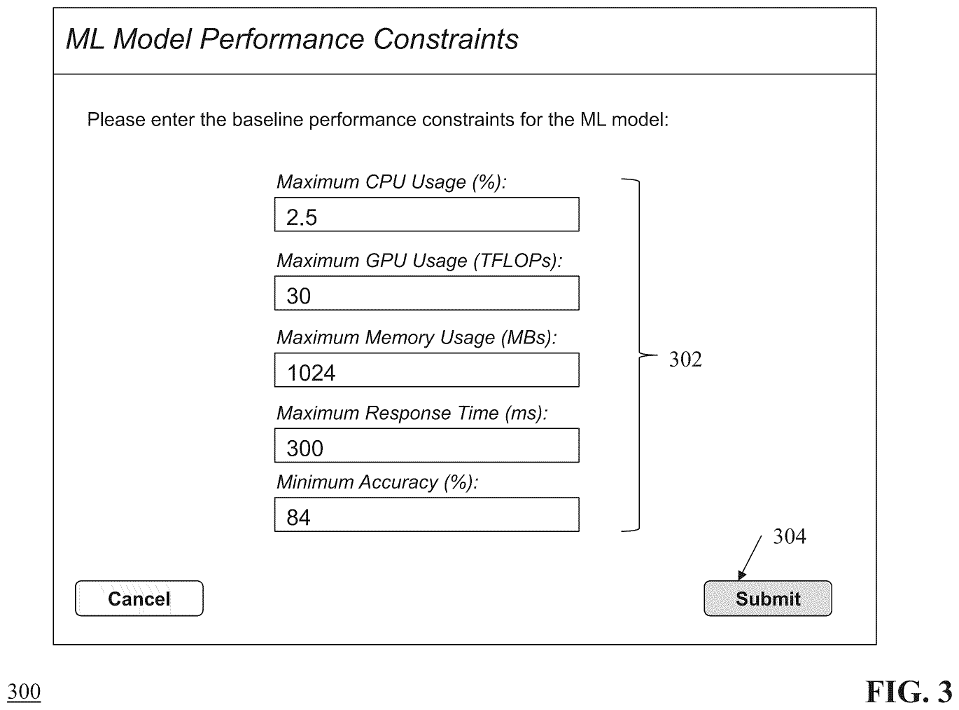

Often, a system administrator designates a baseline set of performance constraints for each production ML classification model-such as maximum response time, maximum CPU usage, maximum memory usage, minimum accuracy, and/or maximum deployment platform cost (e.g., expenditure required to allocate the computing resources necessary to run the ML classification model). The methods and systems described herein can utilize these baseline performance constraints provided by the system administrator for the automated optimization of machine learning models. For example, the system administrator can use client computing device 102 to connect to server computing device 106 (via network 104) and provide the baseline set of performance constraints to be used in determining an optimized architecture for the ML model to be deployed to production. FIG. 3 is a diagram of an exemplary user interface 300 for capturing baseline performance constraints from a user of client computing device 102. As shown in FIG. 3, the user can provide the desired performance constraints 302 using a series of input data fields. The user can then click the submit button 304 to transmit the input constraints to server computing device 106. In some embodiments, server computing device 106 can store the input performance constraints in database server 108. As will be described below, once an ML classification model is deployed to production computing environment 110, system 110 can be advantageously configured to monitor the performance (e.g., CPU usage, memory usage, response time, etc.) and accuracy of the deployed ML model, then use one or more of the monitoring values to refine or modify the baseline performance constraints that are then used by server computing device 106 for generation of new ML models for production and/or re-training of the existing ML model in production. Therefore, the system administrator does not need to provide further input regarding the performance constraints. Instead, system 100 automatically tweaks and improves the performance constraints based upon available performance monitoring statistics—resulting in a self-learning model configuration process.

Once the baseline performance constraints are established, pipeline generation module 106b of server computing device 106 identifies (step 204) candidate machine learning classification model pipelines to be evaluated for potential deployment in production environment 110 as production ML model 110a. Generally, a ML classification model pipeline comprises a combination of data preprocessing technique(s), classification model algorithm(s), and hyperparameter tuning algorithm(s) used by server computing device 106 to build and train an ML classification model. As can be appreciated, a ML classification model pipeline can be constructed using a variety of different combinations of data preprocessing techniques, classification model algorithms, and hyperparameter tuning algorithms—and these combinations have different effects on the overall performance and accuracy of the resulting ML classification model. Therefore, pipeline generation module 106b is configured to generate a plurality of candidate ML classification model pipelines by putting together different combinations of the underlying techniques and algorithms. Pipeline generation module 106b then provides the candidate pipelines to model training and testing module 106c, which trains and tests a ML classification model configured according to each different pipeline and determines which ML classification model(s) meet the performance constraints.

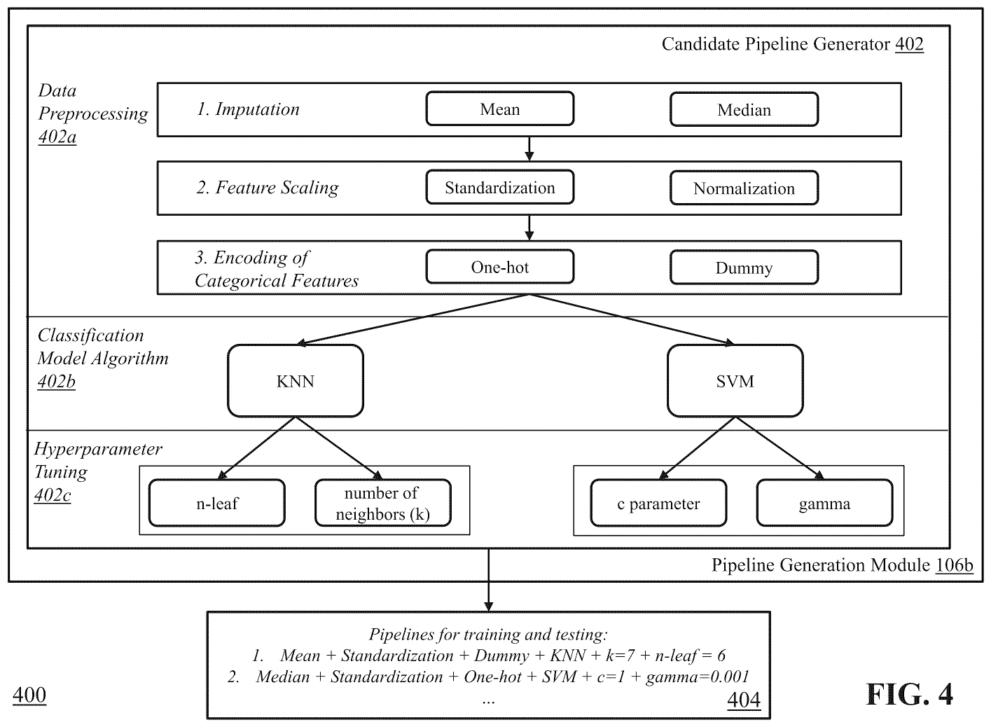

FIG. 4 is a detailed workflow diagram 400 of pipeline generation performed by candidate pipeline generator 402 of pipeline generation module 106b. Candidate pipeline generator 402 of module 106b iterates through three different candidate generation phases: data preprocessing phase 402a, classification model algorithm phase 402b, and hyperparameter tuning phase 402c.

Generally, data preprocessing relates to one or more algorithms or techniques used to process input data before the data is provided to the ML model, so that the ML model is able to properly interpret the data and return accurate classification output. In the data preprocessing phase 402a, module 106b selects a preprocessing function to use for each of three categories: Imputation, Feature Scaling, and Encoding of Categorical Features. Imputation relates to the methodology used to fill in missing or null values from the dataset input to the model. For example, a particular feature in the input dataset may have missing or null values for certain data points and leaving these erroneous values in the dataset could lead to inaccurate output from the model. As a result, imputation is used to generate replacement values for the missing or null values. As shown in FIG. 4, the Imputation category can include mean imputation (i.e., each missing value is replaced with a mean value as determined from the non-missing values for the feature) or median imputation (i.e., each missing value is replaced with a median value as determined from the non-missing values for the feature). It should be appreciated that these types of imputation are merely exemplary and other types of feature scaling can be contemplated for use with the technology described herein.

Feature Scaling relates to the methodology used to transform the values of features in the input dataset in order to ensure that all features contribute equally to the ML model's classification and avoid having certain features (e.g., those with larger values) unduly dominate or influence the model's performance. Generally, feature scaling becomes necessary when the input datasets contain features with different ranges, units of measurement, or orders of magnitude. In these examples, the variation in feature values can lead to biased model performance or difficulties during the model learning/training process. As shown in FIG. 4, the Feature Scaling category can include normalization (i.e., transforming features to be on a similar scale) or standardization (i.e., transforming features by subtracting from mean and dividing by standard deviation). It should be appreciated that these types of feature scaling are merely exemplary and other types of feature scaling can be contemplated for use with the technology described herein.

Encoding of Categorical Features relates to the methodology used to transform categorical features or variables in the input dataset (e.g., features with a finite number of categories or labels for values) into a representation that can be analyzed by the ML classification model. As can be appreciated, categorical features typically have strings for values and most ML classification models do not support strings as input values. Therefore, these categorical features are encoded into numerical values so that the ML classification model can properly interpret the features. As shown in FIG. 4, the Encoding of Categorical Features category can include one-hot encoding or dummy encoding (as described in K. Kuo et al., “Embeddings and Attention in Predictive Modeling,” arXiv: 2104.03545v1 [stat.AP] 8 Apr. 2021 and P. Cerda et al., “Similarity encoding for learning with dirty categorical variables,” arXiv: 1806.00979v1 [cs.LG] 4 Jun. 2018, each of which is incorporated herein by reference). It should be appreciated that these types of encoding are merely exemplary and other types of categorical feature encoding can be contemplated for use with the technology described herein.

At the end of data preprocessing phase 402a, module 106b has selected an imputation technique, a feature scaling technique and an encoding technique to be applied to the input data prior to processing by the ML model. For example, module 106b can generate example partial pipelines as follows:
“Mean”+“Standardization”+“Dummy”
“Median”+“Standardization”+“One-hot”

Next, module 106b proceeds to the classification model algorithm phase 402b where module 106b selects a classification model algorithm to be employed in the resulting ML classification model. As shown in FIG. 4, exemplary classification model algorithms include K-nearest neighbor (KNN) (as described in Z. Zheng, “Introduction to machine learning: k-nearest neighbors,” Ann. Transl. Med. 2016; 4 (11): 218, incorporated herein by reference) and support vector machine (SVM) (as described in C. Hsu et al., “A Practical Guide to Support Vector Classification,” Dept. of Computer Science, National Taiwan University, May 19, 2016, incorporated herein by reference)—although it should be appreciated that other types of classification and/or regression model algorithms can be contemplated for use with the technology described herein. Using the above example partial pipelines output from the data preprocessing phase 402a, module 106b can update the pipelines as:
“Mean”+“Standardization”+“Dummy”+“KNN”
“Median”+“Standardization”+“One-hot”+“SVM”

After selecting a classification model algorithm in phase 402b, module 106b in phase 402c determines hyperparameter tuning to be applied to each candidate pipeline based on the corresponding classification model algorithm assigned to the pipeline. Generally, hyperparameters define how the ML model is structured. Therefore, hyperparameter tuning is important for determining an optimal ML model architecture that achieves accurate results. Module 106b selects default values for each of one or more hyperparameters associated with the classification model and these hyperparameter values are used when building the ML classification model for training and testing. As shown in FIG. 4, when a KNN algorithm is in the candidate pipeline, module 106b selects default hyperparameter values for ‘n-leaf’ and ‘number of neighbors’ parameters. Similarly, when a SVM algorithm is in the candidate pipeline, module 106b selects default hyperparameter values for ‘c parameter’ and ‘gamma’ parameters. The default hyperparameter values can be modified by model training and testing module 106c when evaluating the performance of ML models created using each pipeline, as will be described in detail below. Further information regarding hyperparameter tuning in SVMs and KNNs is described in (i) L. Yang and A. Shami, “On Hyperparameter Optimization of Machine Learning Algorithms: Theory and Practice,” arXiv: 2007.15745v3 [cs.LG] 5 Oct. 2022 and (ii) H. Weerts et al., “Importance of Tuning Hyperparameters of Machine Learning Algorithms,” arXiv: 2007.07588v1 [cs.LG] 15 Jul. 2020, each of which is incorporated herein by reference. It should be appreciated that other types of hyperparameter tuning and related values can be contemplated for use with the technology described herein. Using the above example partial pipelines output from the classification model algorithm phase 402b, module 106b can update the pipelines with default hyperparameter values in phase 402c as: “Mean”+“Standardization”+“Dummy”+“KNN”+n-leaf=6+k=7 “Median”+“Standardization”+“One-hot”+“SVM”+c=1+gamma=0.001

The resulting output 404 from module 106b comprises a plurality of candidate ML classification model pipelines that are provided to model training and testing module 106c to determine whether any of the candidate pipelines can be used to build a ML classification model that conforms to the desired performance constraints.

Turning back to FIG. 2, model training and testing module 106c creates and trains an ML classification model using the configuration provided in each candidate ML model pipeline received from pipeline generation module 106b. Module 106c then evaluates each trained ML classification model to determine whether the model meets the performance constraints as provided from client computing device 102 and selects one of the candidate ML model pipelines that meets the performance constraints for deployment to production computing environment 110.

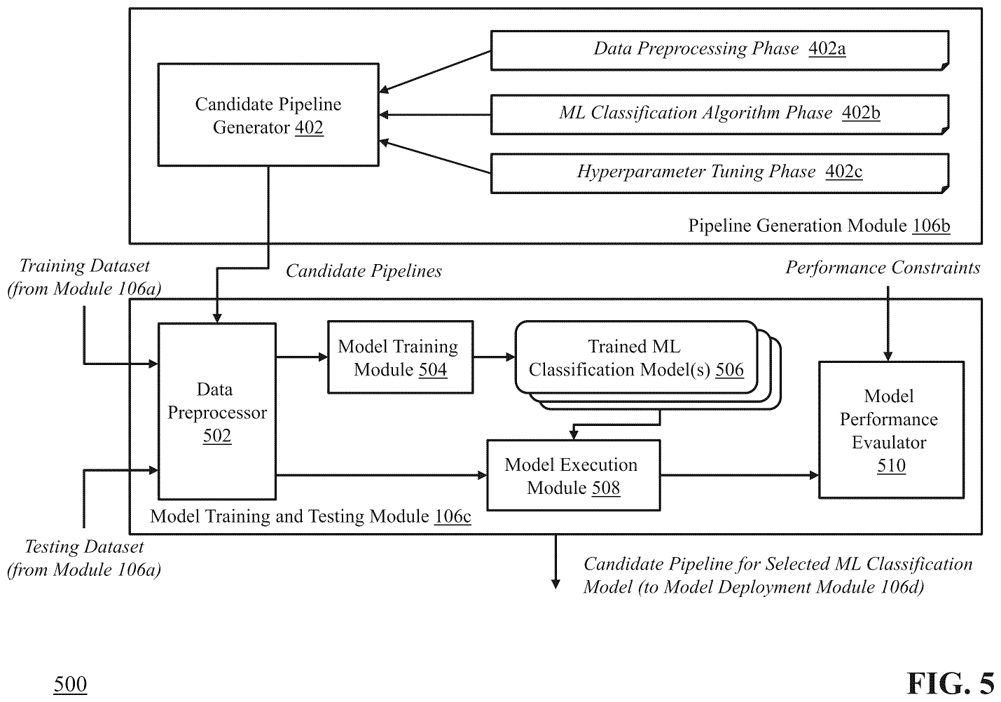

FIG. 5 is a detailed flow diagram 500 of model training and testing module 106c showing the training and testing of ML classification models based upon candidate model pipelines received from pipeline generation module 106b. As shown in FIG. 5 (and described above with respect to FIG. 4), candidate pipeline generator 402 iterates through the data preprocessing phase 402a, ML classification model algorithm phase 402b, and hyperparameter tuning phase 402c to generate a set of candidate ML classification model pipelines which are transmitted to data preprocessor 502 of model training and testing module 106c. Concurrently, data preprocessor 502 of module 106c receives a training dataset from dataset creation module 106a. For example, module 106a can retrieve a training dataset from database 108a, where the training dataset comprises labeled feature data that can be used by module 106c to train new ML classification models. Module 106a transmits the training dataset to data preprocessor 502 and for each candidate pipeline, data preprocessor 502 processes (step 206a) the training dataset using the data preprocessing techniques defined in the pipeline to generate a modified training dataset that is prepared for ingestion by model training module 504. For example, when the pipeline is “Mean”+“Standardization”+“Dummy”+“KNN”+n-leaf-6+k=7, preprocessor 502 performs the steps of mean imputation, standardization feature scaling, and dummy encoding of categorical variables on the training dataset to generate an input dataset that can be provided to model training module 504 for training of new models.

Model training module 504 then trains (step 206b) the ML classification model algorithm defined in the candidate pipeline on the preprocessed training dataset to produce a trained classification model and tunes (step 206c) the trained classification model using the hyperparameter tuning values defined in the pipeline. In some embodiments, module 504 executes a plurality of training runs for the ML classification model algorithm during the training and tuning steps, where for each training run, module 504 tweaks the hyperparameter values and evaluates the result of the training for accuracy (e.g., root mean square error (RMSE), F1 score, ROC curve, etc.)—ultimately settling on specific hyperparameter values that achieve optimal accuracy for the model. Due to the potentially significant processing and bandwidth requirements of training the ML classification models, in some embodiments, module 106c utilizes GPU hardware (e.g., with multiple core processing) to improve the speed of model generation. At the conclusion of this step, module 504 has trained one or more ML classification models 506 which can then be executed using a testing dataset to validate their performance in view of the applicable performance constraints.

The trained ML classification models 506 are provided to model execution module 508, and module 508 executes (step 206d) the trained ML classification models 506 using a testing dataset as input to determine performance characteristics for each trained model 506. As shown in FIG. 5, data preprocessor 502 receives the testing dataset from database 108b via dataset creation module 106a and preprocessor 502 processes the testing dataset using the data preprocessing techniques defined in the pipeline (and which were previously applied to the training dataset) to generate a modified testing dataset that is prepared for ingestion by model training module 504. In the execution phase, the testing dataset is provided to the ML model without the corresponding labels and the ML classification model is tasked with predicting labels for the data points in the testing dataset. Then, accuracy of the ML classification model can be determined by comparing the predicted label to the actual label. In addition, model execution module 508 captures certain performance characteristics associated with execution of the trained ML classification model 506—such as memory usage, CPU usage, GPU usage, and response time—and provides the performance characteristics to model performance evaluator 510 of module 106c.

Model performance evaluator 510 compares (step 206e) the performance characteristics captured by module 508 to the predefined performance constraints (e.g., as provided from client computing device 102) to determine whether the trained ML classification model meets the performance constraints. For example, when the constraints define a maximum CPU usage of 2.5% and an ML classification model associated with a first candidate pipeline reaches a CPU usage of 3.2% during execution, model performance evaluator 502 determines that the ML classification model is not suitable for deployment to production. Conversely, when the constraints define a maximum CPU usage of 2.5% and an ML classification model associated with another candidate pipeline reaches a CPU usage of 1.3% during execution, model performance evaluator 502 determines that the ML classification model is suitable for deployment to production. In some embodiments, evaluator 510 can independently compare each performance constraint to the performance characteristic data to determine whether the ML classification model meets the constraints. In other embodiments, evaluator 510 can determine an overall score for the ML classification model based upon analyzing the performance constraints and performance characteristics in aggregate.

Model performance evaluator 502 identifies (step 208) one of the candidate ML classification model pipelines that meets the performance constraints. In some embodiments, evaluator 502 ranks each of the candidate ML classification model pipelines that is determined as suitable for production based upon the performance characteristics and determines which candidate ML classification model pipeline to select based upon, e.g., which model pipeline exhibits an optimal accuracy score based upon factors such as RMSE, F1 score, and/or ROC curve.

Once evaluator 502 identifies a candidate pipeline that meets the performance constraints, evaluator 502 transmits the candidate pipeline configuration to model deployment module 106d. Module 106d builds (step 210) a production classification model based upon the identified candidate pipeline and deploys (step 212) the production classification model 110a in production computing environment 110. In some embodiments, module 106d trains the production classification model using the training dataset prior to deployment in environment 110. As mentioned above, as the production classification model 110a is executed in production environment 110 over time, model deployment module 106d can capture performance metrics associated with the production model 110a (e.g., CPU usage, memory usage, response time, etc.) and use these captured metrics to adjust the baseline performance constraints that are used in the future. For example, when a particular production model 110a achieves lower CPU usage than the existing baseline value, module 106d can adjust the CPU usage threshold in the baseline constraints to match the captured value.

In some embodiments, model deployment module 106d periodically executes a cron job (e.g., every 90 days) to re-evaluate candidate ML classification model pipelines based upon new input data either generated or captured during use of ML model 110a in production. As can be appreciated, production data used as input for model 110a changes over time and in order to ensure continued accuracy of model 110a, it is crucial to review and retrain model 110a as necessary. Upon executing the cron job, module 106d instructs pipeline generation module 106b to re-initiate the candidate ML classification model pipeline generation described above with updated training data and testing data as well as the current baseline performance constraints (which may have been updated based upon model 110a performance in production). Beneficially, this allows system 100 to determine whether a new ML classification model pipeline is more accurate, more efficient, or generally better suited to be deployed in production environment 110 in place of the existing model. In addition, new data preprocessing techniques, ML classification model algorithms, and/or hyperparameter tuning techniques can be implemented in pipeline generation module 106b for potential inclusion in candidate pipelines without requiring reconfiguration of the entire model generation process.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random-access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above-described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above-described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for constraint-based optimization of machine learning classification models, the system comprising a server computing device having a memory that stores computer-executable instructions and a processor that executes the computer-executable instructions to:
determine performance constraints associated with deployment and execution of a machine learning classification model;
identify a plurality of candidate classification model pipelines, each pipeline comprising a different combination of data preprocessing techniques, a classification model algorithm, and hyperparameter tuning values;
for each candidate classification model pipeline:
processing the training dataset using the data preprocessing techniques,
training the classification model algorithm on the training dataset,
tuning the trained classification model algorithm using the hyperparameter tuning values,
executing the trained classification model using a testing dataset as input to determine performance characteristics for the trained model, and
comparing the performance characteristics to the performance constraints to identify whether the trained model meets the performance constraints;
identify one of the candidate classification model pipelines that meets the performance constraints;
build a production classification model based upon the identified candidate model pipeline; and
deploy the production classification model in a production computing environment.

2. The system of claim 1, wherein the performance constraints comprise a maximum response time, a maximum CPU usage, a maximum memory usage, and a maximum platform execution cost.

3. The system of claim 1, wherein the data preprocessing algorithm comprises an imputation step, a feature scaling step, and an encoding step.

4. The system of claim 3, wherein the imputation step comprises mean imputation or median imputation.

5. The system of claim 3, wherein the feature scaling step comprises standardization or normalization.

6. The system of claim 3, wherein the encoding step comprises one-hot encoding or dummy encoding.

7. The system of claim 1, wherein the classification algorithm comprises a k-nearest neighbor (KNN) algorithm or a support vector machine (SVM) algorithm.

8. The system of claim 7, wherein when the classification model algorithm is a KNN algorithm, the hyperparameter tuning values correspond to an n-leaf parameter and a number of neighbors parameter.

9. The system of claim 7, wherein when the classification algorithm is a SVM algorithm, the hyperparameter tuning values correspond to a c-parameter and a gamma parameter.

10. The system of claim 1, wherein the performance characteristics comprise response time, CPU usage, memory usage, and classification accuracy.

11. The system of claim 10, wherein identifying one of the candidate ML classification model pipelines that meets the performance constraints comprises selecting a candidate ML classification model pipeline associated with an optimal classification accuracy.

12. The system of claim 1, wherein the server computing device:
periodically updates the performance constraints, the training dataset, and the testing dataset,
for each candidate classification model pipeline:
processes the updated training dataset using the data preprocessing techniques, trains the classification model algorithm on the updated training dataset,
tunes the trained classification model algorithm using the byperparameter tuning values,
executes the trained classification model using the updated testing dataset as input to determine performance characteristics for the trained model, and
compares the performance characteristics to the plurality of performance constraints to identify whether the trained model meets the performance constraints;
identifies one of the candidate classification model pipelines that meets the updated performance constraints;
builds a new production classification model based upon the identified candidate model pipeline; and
deploys the new production classification model in the production computing environment.

13. A computerized method of constraint-based optimization of machine learning classification models, the method comprising:
determining, by a server computing device, performance constraints associated with deployment and execution of a machine learning classification model;
identifying, by the server computing device, a plurality of candidate classification model pipelines, each pipeline comprising a different combination of: data preprocessing techniques, a classification model algorithm, and hyperparameter tuning values;
for each candidate classification model pipeline, the server computing device:
processes the training dataset using the data preprocessing techniques,
trains the classification model algorithm on the training dataset,
tunes the trained classification model algorithm using the hyperparameter tuning values,
executes the trained classification model using a testing dataset as input to determine performance characteristics for the trained model, and
compares the performance characteristics to the performance constraints to identify whether the trained model meets the performance constraints;
identifying, by the server computing device, one of the candidate classification model pipelines that meets the performance constraints;
building, by the server computing device, a production classification model based upon the identified candidate model pipeline; and
deploying, by the server computing device, the production classification model in a production computing environment.

14. The method of claim 13, wherein the performance constraints comprise a maximum response time, a maximum CPU usage, a maximum memory usage, and a maximum platform execution cost.

15. The method of claim 13, wherein the data preprocessing techniques comprise an imputation step, a feature scaling step, and an encoding step.

16. The method of claim 15, wherein the imputation step comprises mean imputation or median imputation.

17. The method of claim 15, wherein the feature scaling step comprises standardization or normalization.

18. The method of claim 15, wherein the encoding step comprises one-hot encoding or dummy encoding.

19. The method of claim 13, wherein the classification model algorithm comprises a k-nearest neighbor (KNN) algorithm or a support vector machine (SVM) algorithm.

20. The method of claim 19, wherein when the classification model algorithm is a KNN algorithm, the hyperparameter tuning values correspond to an n-leaf parameter and a number of neighbors parameter.

21. The method of claim 19, wherein when the classification algorithm is a SVM algorithm, the hyperparameter tuning values correspond to a c-parameter and a gamma parameter.

22. The method of claim 13, wherein the performance characteristics comprise response time, CPU usage, memory usage, and classification accuracy.

23. The method of claim 22, wherein identifying one of the candidate classification model pipelines that meets the performance constraints comprises selecting a candidate classification model pipeline associated with an optimal classification accuracy.

24. The method of claim 13, wherein the server computing device:
periodically updates the performance constraints, the training dataset, and the testing dataset,
for each candidate classification model pipeline:
processes the updated training dataset using the data preprocessing techniques, trains the classification model algorithm on the updated training dataset, tunes the trained classification model algorithm using the hyperparameter tuning values,
executes the trained classification model using the updated testing dataset as input to determine performance characteristics for the trained model, and
compares the performance characteristics to the plurality of performance constraints to identify whether the trained model meets the performance constraints;
identifies one of the candidate classification model pipelines that meets the updated performance constraints;
builds a new production classification model based upon the identified candidate model pipeline; and
deploys the new production classification model in the production computing environment.
